(19) United States
(12) Patent Application Publication
(10) Pub. No.: US 2014/0277623 A1
(43) Pub. Date: Sep. 18, 2014

(54) GRAPHICS DRIVEN MOTION CONTROL

(71) Applicant: TAIT TOWERS MANUFACTURING, LLC, Lititz, PA (US)

(72) Inventors: James D. LOVE, Lititz, PA (US); Scott FISHER, Las Vegas, NV (US)

(73) Assignee: TAIT TOWERS MANUFACTURING, LLC, Lititz, PA (US)

(21) Appl. No.: 13/826,409

(22) Filed: Mar. 14, 2013

(51) Int. Cl. G05B 15/02

(52) U.S. Cl. CPC G05B 15/02
USPC 700/86; 700/275

(57) ABSTRACT

An automation and motion control system controls a plurality of theatrical objects. The automation and control system includes a data network, an operator console, remote station, input/output devices and external system; an emergency stop (e-stop) system; a machinery piece; and a control system. The control system includes industrial protocols and software interfaces. The control system generates a digital video graphics file from an original video image file and converts the digital video graphics file to a grayscale digital file. The control system transmits the grayscale digital file to a visual profile generator and a movement control device, receives the grayscale pixel maps from the grayscale conversion module; and generates a visual profile by the visual profile generator. The visual profile is a format compatible with a motion automation and control system.

### BACKGROUND

The application generally relates to automated motion control systems for live performances. The application relates more specifically to converting graphic files to motion control instructions automatically.

In the entertainment industry, to provide a realistic atmosphere for a theatrical production, theatrical objects or components can be moved or controlled by an automation and motion control system (MCS) during and in between scenes on a stage or takes on a motion picture production set. MCS may be applied to equipment to service a variety of automation applications, e.g., standard theatrical lineset systems, multi-discipline, themed attraction and show control systems, complete pre-vis, camera control, and motion control integration for motion picture grip, stunt, and special effects equipment.

Automation of the movement and control of the theatrical objects or components is desirable for safety, predictability, efficiency, and economics. Theatrical object movement and control systems provide for the control and movement of the theatrical objects or components under the control of a central computer or microprocessor. A large number of devices using lists of sequential actions or instructions may be executed by one or more computers. For example, the motorized movement of the objects could be provided by drive motors, which may or may not use variable speed drives, coupled to the central computer, possibly through one or more intermediate controllers. Some theatrical object movement and control systems employ separate subsystems to control movement. Each subsystem may have a programmable logic controller (PLC), to handle the control of device functionality. When using PLCs, the operator monitors the system via separate inputs from the separate subsystems and then take separate actions for each of the subsystems.

For example, motorized winches are frequently used to suspend and move objects, equipment and/or persons above the ground to enhance live performances, such as sporting events or theatrical/religious performances, or to increase the realism of movie or television productions. Several motorized winches may be used to suspend and move a person or object in the air during a theatrical performance to give the appearance that the person or object is “flying” through the air. In another example, a camera could be suspended over the playing surface of a sporting event to capture a different aspect of the action occurring on the playing surface.

The theatrical object movement and control system typically operates by receiving input parameters such as a three dimensional (3D) motion profile that specifies X, Y and Z coordinates in a motion profile for an object in the space controlled by the MCS. In addition to X, Y and Z coordinates, motion profiles can also include alpha, beta and gamma angles of the object, a time parameter which coordinates the position to an instance in time, and acceleration, deceleration and velocity parameters for both the coordinates and the angles. In the scenes there may also be static elements, i.e., elements that do not move in the predefined space, such as stage props or background scenery, and two-dimensional (2D) moving scenery.

Constructing the input files for motion profiles can be costly and tedious, and requires substantial preparation and resources to re-create in a format that can be digitally processed to generate the required movements.

A MCS is needed that can automatically translate movement and reproduce independent movement of objects through digitally controlled devices, e.g., cable winches.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to an automation and motion control system that controls a plurality of theatrical objects. The automation and control system includes a data network, an operator console, remote station, input/output devices and external system; an emergency stop (e-stop) system; a machinery piece; and a control system. The control system includes industrial protocols and software interfaces. The control system generates a digital video graphics file from an original video image file and converts the digital video graphics file to a grayscale digital file. The control system transmits the grayscale digital file to a visual profile generator and a movement control device, receives the grayscale pixel maps from the grayscale conversion module; and generates a visual profile by the visual profile generator. The visual profile is a format compatible with a motion automation and control system.

Another embodiment relates to a method for converting graphic files to motion control instructions. The method includes generating a digital video graphics file from an original video image file; converting the digital video graphics file to a grayscale digital file transmitting the grayscale digital file to a visual profile generator and a movement control device; receiving the grayscale pixel maps from the grayscale conversion module, and generating a visual profile by the visual profile generator, the visual profile comprising a format compatible with a motion automation and control system; and generating position commands by the movement control device based on the visual profile.

Certain advantages of the embodiments described herein are the ability to convert graphic files to motion control instructions for special effects in theatrical productions.

Alternative exemplary embodiments relate to other features and combinations of features as may be generally recited in the claims.

### BRIEF DESCRIPTION OF THE FIGURES

FIG. 1 is a process block diagram illustrating generally the method of 3D motion control based on a graphics video input file.

FIG. 2A is a representation of a kinetic sculpture embodied by a layer or plurality of spheres in a 3D space.

FIG. 2B is a representation of a video input file driving the automation for the kinetic sculpture of FIG. 2A.

FIG. 3A is an alternate arrangement of the kinetic sculpture.

FIG. 3B is a representation of an alternate video input file driving the automation for the kinetic sculpture of FIG. 3A.

FIG. 4A is an alternate arrangement of the kinetic sculpture.

FIG. 4B is a representation of a video input file driving the automation for the kinetic sculpture of FIG. 4A.

FIG. 5A is an alternate arrangement of the kinetic sculpture.

FIG. 5B is a representation of an alternate video input file driving the automation for the kinetic sculpture of FIG. 5A.

FIG. 6 shows an exemplary embodiment of an automation and control system including a real time data network.

FIG. 7 shows an alternate embodiment of the automation and motion control system.

FIG. 8 shows an exemplary embodiment of a node.

FIG. 9 shows an exemplary embodiment of an LED display on a lift.

### DETAILED DESCRIPTION OF THE EXEMPLARY EMBODIMENTS

Referring first to FIG. 1, a process block diagram 100 illustrates the general steps required to generate 3D motion control based on a graphics video input file. Initially, at step 100, a digital video graphics file is generated using conventional means known to those persons skilled in the art. For example, an existing video file, e.g., from a movie or television program may be processed into a digital video graphics file. In another embodiment, the digital video graphics file may created by recording a live or simulated performance. In one embodiment multiple video cameras may be used to generate multiple video source files for viewing and synchronizing movement and position of objects from various angles. At step 102, the digital video file or files are input to a grayscale conversion module. The grayscale conversion module may employ, e.g., decolorizing algorithms used to process the color video input files to a grayscale pixel map or maps, and provide position information for the images depicted in the video input files.

Next, the output of the grayscale conversion module is sent to two different processing steps. At step 104, a visual profile generator receives the grayscale pixel maps from the grayscale conversion module, and generates a visual profile into a format that is compatible with a motion automation and control system described in greater detail below.

Referring to FIGS. 2A & 2B, in one embodiment a kinetic sculpture 12 is driven by a video image or content 14. Kinetic sculpture 12 is an array of spheres 16 disposed in a layer on a bottom surface or floor 18 of a 3D space 20. The position of spheres 16 is associated with video content 14 that is driving the automation. Video content is played by the video system and transferred to the automation system to move the motors. In this example, a solid black image represents all spheres 16 arrayed on floor 18. A top surface or ceiling 22 opposite floor 18 may include a reflective surface or coating to reflects the images of spheres 16 disposed on the floor.

Referring next to FIGS. 3A and 3B, video content 14b is now changed to represent a solid white image. Kinetic sculpture 12 rearranges spheres 16 in response to video content 14b, so that spheres 16 are disposed on ceiling 22, i.e., opposite of the solid black image 14a.

Referring next to FIGS. 4A and 4B, video content 14c is now changed to represent a striped pattern of white and black stripes. In kinetic sculpture 12, stripes are translated to positions in which alternating rows of spheres 16 are disposed on the floor 18 and ceiling 22. Note that the rows of spheres 16 may be positioned at different elevations, i.e., while in transition, or as a design to impose waveforms along the rows.

Referring next to FIGS. 5A and 5B, in another embodiment video content 14c may represent a random dotted pattern with black dots 24 on a white background 26. kinetic sculpture 12 changes the position of spheres 16 in kinetic sculpture 12 corresponding with the relative positions of dots 24 in video content 14c. Spheres 16 may be positioned at the same or different elevations between floor 18 and ceiling 22.

While video content 14c is shown as a static image in FIGS. 2B-5B, video content containing moving images may be used to generate movement of spheres 16 within 3D space 20.

From step 104, the system proceeds to step 106, to generate position commands for the movement control devices, based on the visual profile 16.

In one exemplary embodiment, movement control devices may be motorized winches. Motorized winches in the system may be configured to work in a coordinated manner, e.g., to avoid collisions between an object or equipment being suspended with another object or structure. Coordinated control of motorized winches is accomplished by transmitting control instructions to the motorized winches via an intermediate controller or drive rack 213. Drive rack 213 may be located between the user interface 215 and the motorized winches. Drive rack 213 generates and provides the individual instructions to the motorized winch, e.g., extend or retract cable commands, cable speed commands or cable distance commands. In addition, drive rack may receive feedback data from each motorized winch relating to the operational status of the motorized winches. Drive rack 213 may provide control instructions to the motorized winches to sequence or coordinate the operation of the motorized winches.

Position commands are sent to a motion control drive at step 116, and lifts and other motion devices are controlled according to movement paths depicted in the original video image file or files. In one embodiment a motor drive includes drive rack 213. Drive rack 213 includes configuration files containing data to configure motor drives from various manufacturers. Configuration files contain all of the information necessary to configure the actual motion control aspects of the axis. The motion controller communicates commands to a properly configured motor drive. The motor drive is pre-programmed with the appropriate parameters according to the motor manufacturer's specifications. The motor drive control software may be provided by the manufacturer and connected directly to the motor drive, e.g., via a laptop computer to do the setup and configuration. Alternately the motor drive software can be pre-programmed to read, store, write, and edit drive parameters for the most commonly used models directly from a user interface 215. Motor drive parameters may be accessed by selecting an axis tile, and viewing motor drive parameters through, e.g., a tools menu. Encoder data and all of the available drive parameters are provided through a dialog box in a graphical user interface 215.

The scaled encoder values in and raw encoder values are provided in a first display section, and drive manufacturers, e.g., SEW Eurodrive, and associated drive parameters to be written to the drive configuration file are provided in a second display section. Drive parameters may be selected and displayed from the second display section. In one embodiment the user may transfer a pre-saved drive parameter file to a new motor drive, e.g., using a “write drive parameters” function.

Parameter files may be saved for multiple motor drives in the system once the system has been tuned and commissioned. Parameter files enable the user to reproduce or “clone” a new or replacement motor drive with the original parameters or to facilitate transfer of motor drive parameter files to multiple drives that utilize the same configuration.

Referring again to FIG. 1, at step 108, a media server receives the actual position of the machine, e.g., from an encoder, for movement control devices, as well as video content from step 110. Video content is generated based on the output of the grayscale conversion module generated at step 102. The media server may receive position commands for the movement or the “actual position” of the machine measure by a device like an encoder. The commanded position and the actual position can be different since there are physical limitations of the machine that may prevent from going to the commanded position. Also, the machine can malfunction which would cause it to not be at the commanded position. By giving the actual position instead of the commanded position, the media server displays video that relates to the actual position of the machine.

Referring to FIG. 9, in one exemplary embodiment, a video processor 30 may be provided to process control signals and images for a lift matrix 31 supporting an LED display 32. LED display 32 receives video image files from video processor 30 at step 112. Video processor 30 converts the color video input files to a grayscale pixel map or maps, and provides position information for the images depicted in the video input files.

Video processor output signals 34 are then used to control LED display 32/lift matrix 31, at step 114. In one exemplary embodiment the converted grayscale pixel maps may be generated in Art-net protocol and transmitted via the network to LED display 32 mounted on lift 31, e.g., a hydraulic, pneumatic or mechanical lift supporting LED matrix. In one embodiment the greyscale pixel maps may be configured in a 4 pixel by 9 pixel 16-bit array. Greyscale pixel maps may be used to control motion of the lift, and the position of images on LED display 32 relative to lift 31. E.g., a video image 36 may be displayed on LED display 32 such that image 36 moves up and down as the lift moves up and down. Conversely the video image may be displayed on the LED matrix such that the images appears to be moving up or down while the lift is stationary.

FIG. 9 illustrates an exemplary embodiment of a video system described above. Video processor 30 may represent an image in 16-bit pixels 35, e.g., a 4 pixel by 9 pixel array 37. Array 37 may be implemented as an Art-net lighting control protocol to display image 36 on LED display 32 mounted on lift matrix 31. The position of the image may be controlled by video processor 30 using the greyscale representation to control motion. In FIG. 9, the top row 40 represents the original video content or image 36, which in the example shows a person walking.

The bottom row 42 illustrates the movement of image 36 relative to display 32. The greyscale representation may be used to control motion of lift 31, as image 36 is displayed on LED display 32. The image position may be controlled to move relative to the display. The person is walking as provided in the original video content, however the position of the person walking is displayed as descending relative to LED display 32, which is stationary. This feature provides the ability to control movement of the image without changing the image, by adjusting the position of image 36 on LED display 32. In the first frame 42a, image 36 fills the entire LED display 32. In the next frame 42b, display 32 is in the same position, but image 36 is shifted downward with respect to display 32, with the cross-hatched area of image 36 being outside the boundary of display 32. Similarly, in the following frame 42c, more of image 36 has been shifted downward relative to display 32, and the cross-hatched area of image 36 is increased. In the final frame 42d, image 36 has moved entirely outside of the boundary of LED display 32, leaving LED display 32 blank. Alternately, LED display 32 may be moving, e.g., as the position of lift 31 changes vertically, with image 36 remaining stationary, or at the same elevation, thus providing the illusion of motion relative to LED display 32.

Referring next to FIG. 6, the automation and control system 200 can include a real time data network 210 interconnecting drive racks 213 and operator consoles 215, remote stations 220, safety systems 225, machinery 230, input/output devices 135 and external systems 140. In one exemplary embodiment, safety systems 225 can include emergency stop (e-stop) systems; machinery 230 can include lifts, chain hoists, winches, elevators, carousels, turntables, hydraulic systems, pneumatic systems, multi-axis systems, linear motion systems (e.g., deck tracks and line sets), audio devices, lighting devices, and/or video devices; input/output devices 235 can include incremental encoders, absolute encoders, variable voltage feedback devices, resistance feedback devices, tachometers and/or load cells; and external systems 240 can include show control systems, industrial protocols and third party software interfaces including 0-10 V (volt) systems, Modbus systems, Profibus systems, ArtNet systems, BMS (Building Management System) systems, EtherCat systems, DMX systems, SMPTE (Society of Motion Picture and Television Engineers) systems, VITC systems, MIDI (Musical Instrument Digital Interface) systems, MANET (Mobile Ad hoc NETwork) systems, K-Bus systems, Serial systems (including RS 485 and RS 232), Ethernet systems, TCP/IP (Transmission Control Protocol/Internet Protocol) systems, UDP (User Datagram Protocol) systems, ControlNet systems, DeviceNet systems, RS 232 systems, RS 45 systems, CAN bus (Controller Area Network bus) systems, Maya systems, Lightwave systems, Catalyst systems, 3ds Max or 3D Studio Max systems, and/or a custom designed system.

FIG. 8 schematically shows an exemplary embodiment of a node. Each node 210 (or operator console node 215) includes a microprocessor 310 and a memory device 315. The memory device 315 can include or store a main or node process 317 that can include one or more sub- or co-processes 320 that are executable by the microprocessor 310. The main or node process 317 provides the networking and hardware interfacing to enable the sub- or co-processes to operate. The microprocessor 410 in a node 210, 215 can operate independently of the other microprocessors 410 in other nodes 310, 315. The independent microprocessor 410 enables each node 310, 315 in the control system 200 or 300 to operate or function as a “stand-alone” device or as a part of a larger network. In one exemplary embodiment, when the nodes 310, 315 are operating or functioning as part of a network, the nodes 310, 315 can exchange information, data and computing power in real time without recognizing boundaries between the microprocessors 410 to enable the control system 200, 300 to operate as a “single computer.” In another embodiment, each node may use an embedded motion controller.

FIG. 7 shows an alternate embodiment of the automation and motion control system. The automation and motion control system 300 shown in FIG. 3 can be formed from the interconnection of logical nodes 310. Each node 310 can be a specific device (or group of devices) from remote stations 320, safety systems 325, machinery 330, input/output devices 335 and external systems 340. Nodes 310 may include, e.g., axis controllers, Estop controllers, I/O controllers, consoles and show controllers. An operator console node 315 can be a specific device from operator consoles 315 and can enable an operator to interact with the control system 300, i.e., to send data and instructions to the control system 300 and to receive data and information from the control system 300. The operator console node 315 is similar to the other nodes 310 except that the operator console node 315 can include a graphical user interface (GUI) or human-machine interface (HMI) to enable the operator to interact with the control system 100. In one exemplary embodiment, the operator console node 215 can be a Windows® computer.

In one exemplary embodiment, the operator(s) can make inputs into the system at operator console nodes 215 using one or more input devices, e.g., a pointing device such as a mouse, a keyboard, a panel of buttons, or other similar devices. As shown in FIG. 7, nodes 310 and operator console nodes 315 are interconnected with each other. Thus, any node 310, 315 can communicate, i.e., send and receive data and/or instructions, with any other node 310, 315 in the control system 300. In one exemplary embodiment, a group of nodes 310 can be arranged or configured into a network 212 that interconnects the nodes 310 in the group and provides a reduced number of connections with the other nodes 310, 315. In another exemplary embodiment, nodes 310, 315 and/or node networks 312 can be interconnected in a star, daisy chain, ring, mesh, daisy chain loop, token ring, or token star arrangement or in combinations of those arrangements. In a further exemplary embodiment, the control system 300 can be formed from more or less nodes 310, 315 and/or node networks 312 than those shown in FIG. 7.

In one exemplary embodiment, each node 310, 315 can be independently operated and self-aware, and can also be aware of at least one other node 310, 315. In other words, each node 310, 315 can be aware that at least one other node 310, 315 is active or inactive (e.g., online or offline).

In another exemplary embodiment, each node may be independently operated using decentralized processing, thereby allowing the control system to remain operational even if a node may fail because the other operational nodes still have access to the operational data of the nodes. Each node can be a current connection into the control system, and can have multiple socket connections into the network, each providing node communications into the control system through the corresponding node. As such, as each individual node is taken “offline,” the remaining nodes can continue operating and load share. In a further exemplary embodiment, the control system can provide the operational data for each node to every other node all the time, regardless of how each node is related to each other node.

It is important to note that the construction and arrangement of the graphics driven motion control system and method, as shown in the various exemplary embodiments is illustrative only. Although only a few embodiments have been described in detail in this disclosure, those who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

As noted above, embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

What is claimed is:

1. An automation and motion control system to control a plurality of theatrical objects, the control system comprising:
a data network, an operator console, at least one remote station, at least one input/output devices and an external systems;
at least one machinery piece;
and a control system comprising industrial protocols and software interfaces;
wherein the control system is configured to:
generate a digital video graphics file from an original video image file;
convert the digital video graphics file to a grayscale digital file;
transmit the grayscale digital file to a visual profile generator and a movement control device;
receive the grayscale pixel maps from the grayscale conversion module; and
generate a visual profile by the visual profile generator, the visual profile comprising a format compatible with a motion automation and control system.

2. The system of claim 1, wherein the control system is further configured to:
generate a position command by the movement control device based on the visual profile.

3. The system of claim 2, wherein the control system is further configured to:
forward position commands to a motion control drive; and
control motion devices according to a movement path represented in the original video image file.

4. The system of claim 3, wherein the control system is further configured to:
receive position commands at a media server and generate video content on the output of the grayscale conversion module.

5. The system of claim 4, wherein the control system is further configured to receive and process the video image files from the media server.

6. The system of claim 1, wherein the at least one machinery piece comprises a lift, chain hoists, winches, elevators, carousels, turntables, hydraulic systems, pneumatic systems, multi-axis systems, linear motion systems (e.g., deck tracks and line sets), audio devices, lighting devices, and/or video devices;

7. The system of claim 1, wherein the input/output devices comprise incremental encoders, absolute encoders, variable voltage feedback devices, resistance feedback devices, tachometers and/or load cells.

8. The system of claim 1, wherein the video file comprises a movie or television program processed into a digital video graphics file.

9. The system of claim 1, wherein the video profile is a kinetic sculpture.

10. The system of claim 9, wherein the kinetic sculpture comprises an array of spheres disposed in a layer on a bottom surface of a 3D space, the spheres positioned according to the video profile.

11. The system of claim 10, wherein a solid black image corresponds with the spheres arrayed on the bottom surface.

12. The system of claim 10, wherein the 3D space further includes a top surface opposite the bottom surface, wherein the top surface comprises a reflective surface to reflect the images of spheres disposed on the bottom surface.

13. The system of claim 9, wherein video content comprises a solid white image, and the kinetic sculpture comprises an array of spheres in response to the video content, the spheres disposed on a top surface of a 3D space.

14. The apparatus of claim 9, wherein the kinetic sculpture comprises an array of spheres disposed in a 3D space, the array of spheres represented by a striped pattern comprising white and black stripes, wherein the stripes are translated to positions in which alternating rows of the spheres are disposed on the bottom surface and the top surface.

15. The system of claim 14, wherein the rows of spheres are disposed at different elevations while in transition, to impose waveforms along the rows.

16. The apparatus of claim 5, wherein the kinetic sculpture comprises an array of spheres disposed in a random dotted pattern with a plurality of dots on a contrasting background, wherein the kinetic sculpture changes the position of the spheres in the kinetic sculpture in response to the relative positions of the plurality of dots 24 in the video content

17. The system of claim 16, wherein the spheres are positioned at the same or different elevations between the bottom surface and the top surface.

18. A method for converting graphic files to motion control instructions comprising:
generating a digital video graphics file from an original video image file;
converting the digital video graphics file to a grayscale digital file
transmitting the grayscale digital file to a visual profile generator and a movement control device;
receiving the grayscale pixel maps from the grayscale conversion module, and generating a visual profile by the visual profile generator, the visual profile comprising a format compatible with a motion automation and control system; and
generating position commands by the movement control device based on the visual profile.

19. The method of claim 18, further comprising:
forwarding position commands to a motion control drive; and
controlling motion devices according to a movement path represented in the original video image file.

20. The method of claim 19, further comprising receiving position commands at a media server and generating video content on an output of the grayscale conversion module; and receiving and processing the video image files from the media server.
